(19) United States
(12) Patent Application Publication
(10) Pub. No.: US 2020/0242573 A1
(43) Pub. Date: Jul. 30, 2020

(54) CRYPTOGRAPHIC TRANSACTIONS SUPPORTING REAL WORLD REQUIREMENTS

(71) Applicant: Sensoriant, Inc., Cedar Knolls, NJ (US)

(72) Inventors: Shamim A. Naqvi, Morristown, NJ (US); Robert F. Raucci, New York, NY (US)

(21) Appl. No.: 16/751,585

(22) Filed: Jan. 24, 2020

Related U.S. Application Data
(60) Provisional application No. 62/796,241, filed on Jan. 24, 2019.

(51) Int. Cl. G06Q 20/06; G06Q 20/38; G06Q 20/40; G06Q 20/02; H04L 9/32

(52) U.S. Cl. CPC G06Q 20/065; G06Q 20/3821; G06Q 20/405; H04L 2209/56; H04L 9/3218; G06Q 2220/00; G06Q 20/02

(57) ABSTRACT

In accordance with a method of generating a cryptographic coin., a first spending right cryptographic credential is generated using a proof of zero knowledge protocol. The first spending right cryptographic credential includes a first cryptocurrency component and a proof that verifies that a first cryptocurrency transaction logic produced the first cryptocurrency component using as input a first spending right. A second spending right cryptographic credential is generated using the proof of zero knowledge protocol. The second spending right cryptographic credential includes a second cryptocurrency component and a proof that verifies that a second cryptocurrency transaction logic produced the first cryptocurrency component using as input a second spending right. A cryptographic coin is generated using service logic that encapsulates the first and second spending right cryptographic credentials using the proof of zero knowledge protocol. The cryptographic coin further includes a proof that verifies that the service logic produced the cryptographic coin.

### BACKGROUND

Digital or cryptographic currencies (also called cryptocurrencies) have been developed that can be used to provide payment for goods and services. Cryptocurrencies are a medium of exchange designed around securely exchanging and storing value. A cryptocurrency can be either centralized or decentralized. Cryptocurrencies often require a digital wallet in order to make or receive payments. A wallet is a computer program that maintains a counter that can be incremented or decremented as a result of a transaction. The state of the counter is maintained across multiple transactions. When the counter represents a cryptocurrency, the wallet containing the counter may be referred to as a currency wallet. A user communication device may implement a wallet through a computer program that generates an interface to enable a user to make deposits, withdrawals and to spend crypto currency.

Many cryptocurrencies have been introduced in the last decade and it has been observed that the monetary value of such currencies may fluctuate wildly with respect to fiat currencies. Fiat currencies refer to currencies without intrinsic value but which derive their value from government regulation or law. Examples of fiat currencies include U.S. dollars, Euros and Yuans. The exchange rate of cryptocurrencies to fiat-currencies has been extremely volatile, which has led to speculation and some holders of cryptocurrencies experiencing large gains or losses. For example, the cryptocurrency called Bitcoin lost more than half its value in the year 2018 with respect to the US dollar. Due to this, many businesses and individuals are reluctant to hold cryptocurrencies or to use them as a currency for business transactions. It is now generally recognized that most cryptocurrencies are poor stores of value.

To circumvent this problem, technologists have proposed various so-called stable currencies. In one type of stable currency, the currency is pegged to one or more fiat currencies. For example, the currency called Tether is pegged to the US dollar. In such systems, the digital currency is usually backed by reserves of fiat currency.

In another type of stable currency, various policies are used to stabilize the value of the currency. For example, the coin called Basis proposed increasing the money supply by issuing new coins or decreasing the money supply by issuing bonds in the basis cryptocurrency in order to maintain the value of the basis cryptocurrency within a certain pre-determined range with respect to fiat currencies over some period of time.

However, the efficacy of stabilization methods remains to be ascertained. For example, the company issuing Basis coins recently announced termination of operations citing regulatory problems with its proposed instruments for enforcing monetary policy. Additionally, a central tenet in cryptocurrencies is the notion of decentralization by which no single entity is deemed to control the currency. An agency enforcing monetary policy, by definition, controls the currency.

Despite the benefits of cryptocurrencies, some applications have been criticized as not complying with government regulations regarding money transfers. These regulations include Anti-Money Laundering (AML) policies and Know-Your-Customer (KYC) requirements. Cryptocurrency transactions have been associated with criminal activities and this causes legitimate businesses and banks to avoid their use. There is a lack of trusted cryptocurrency exchanges that businesses are willing to use. In particular, public companies or companies subject to regulatory or audit requirements may be prohibited from using exchanges that do not comply with certain government regulations.

In part because of these government regulations, as well as for practical reasons, the number of kinds of transactions requiring personal information from users is increasing, especially in online commerce. For example, many online transactions involving goods to be delivered to a customer require a street address. Sports gaming websites require proof of age, citizenship and address. Similarly, alcohol purchases and computer game stores are required by regulators to ask customers for proof of age and residence.

Responding to such privacy concerns, technologists have proposed various anonymity schemes based on cryptographic technologies that protect the identity of consumers. Such techniques, however, have an unwanted consequence, viz., certain consumers engage in illicit transactions, e.g., purchase of illicit goods, or fail to pay taxes and flout regulations. Increasingly, anonymity-based transaction schemes are being subjected to increased scrutiny by regulators.

### SUMMARY

It is one goal of the present invention to support such real-world considerations in cryptographic transactions as espoused and required by consumers, merchants and governments.

In one aspect, a method and apparatus is presented of generating a cryptographic coin. In accordance with the method, a first spending right cryptographic credential is generated using a proof of zero knowledge protocol. The first spending right cryptographic credential includes a first cryptocurrency component and a proof that verifies that a first cryptocurrency transaction logic produced the first cryptocurrency component using as input a first spending right. A second spending right cryptographic credential is generated using the proof of zero knowledge protocol. The second spending right cryptographic credential includes a second cryptocurrency component and a proof that verifies that a second cryptocurrency transaction logic produced the first cryptocurrency component using as input a second spending right. A cryptographic coin is generated using service logic that encapsulates the first spending right cryptographic credential and the second spending right cryptographic credential using the proof of zero knowledge protocol. The cryptographic coin further includes a proof that verifies that the service logic produced the cryptographic coin.

In another aspect, a method and apparatus of performing a transaction with a third party using a communication device is presented. In accordance with the method, a specification of one or more items that are to be provided to a third party to perform the transaction is received at the communication device from the third party. The one or more items include an amount of payment that is to be provided to the third party. The communication device is used to cause a cryptographic coin to be generated. The cryptographic coin includes at least a first spending right cryptographic credential that is generated using a proof of zero knowledge protocol. The first spending right cryptographic credential includes a first cryptocurrency component in an amount equivalent to the payment amount needed to perform the transaction, and a proof that verifies that a first cryptocurrency transaction logic produced the first cryptocurrency component. The communication device is used to cause the cryptocurrency coin to be provided to the third party.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows one example of a cryptocurrency environment in which cryptocurrency transactions may be performed between two parties.

FIG. 2 shows one example of the payment service shown in FIG. 1.

FIG. 3 shows one example of the messages exchanged between a user communication device and a merchant device when executing a two-legged transaction that employs a smart contract to mediate the transaction.

FIG. 4 a schematic block diagram of the components used to generate and verify the cryptographic coins or token and the various cryptographic keys used in one example of the proof of zero knowledge protocol.

FIG. 5 shows an exemplary cryptographic coin comprising a spending right cryptographic credential and a user data cryptographic credential.

FIG. 6 shows an example of a cryptographic coin or token that includes payment cryptographic credentials as well as user data cryptographic credentials.

FIG. 7 shows one particular implementation of the cryptocurrency environment of FIG. 1 in which the cryptocurrency that is employed is based on the coins or tokens in which spending rights are incorporated in verifiable cryptographic credentials.

FIG. 8 illustrates an example of a transaction that occurs between a customer communication device equipped with a digital wallet and a merchant device such as merchant website using a coin or token having two spending right components.

FIG. 9 shows one example of the exchange of messages between a consumer communication device and a currency exchange.

FIG. 10 illustrates a payment being made by a consumer communication device to a merchant website.

### DETAILED DESCRIPTION

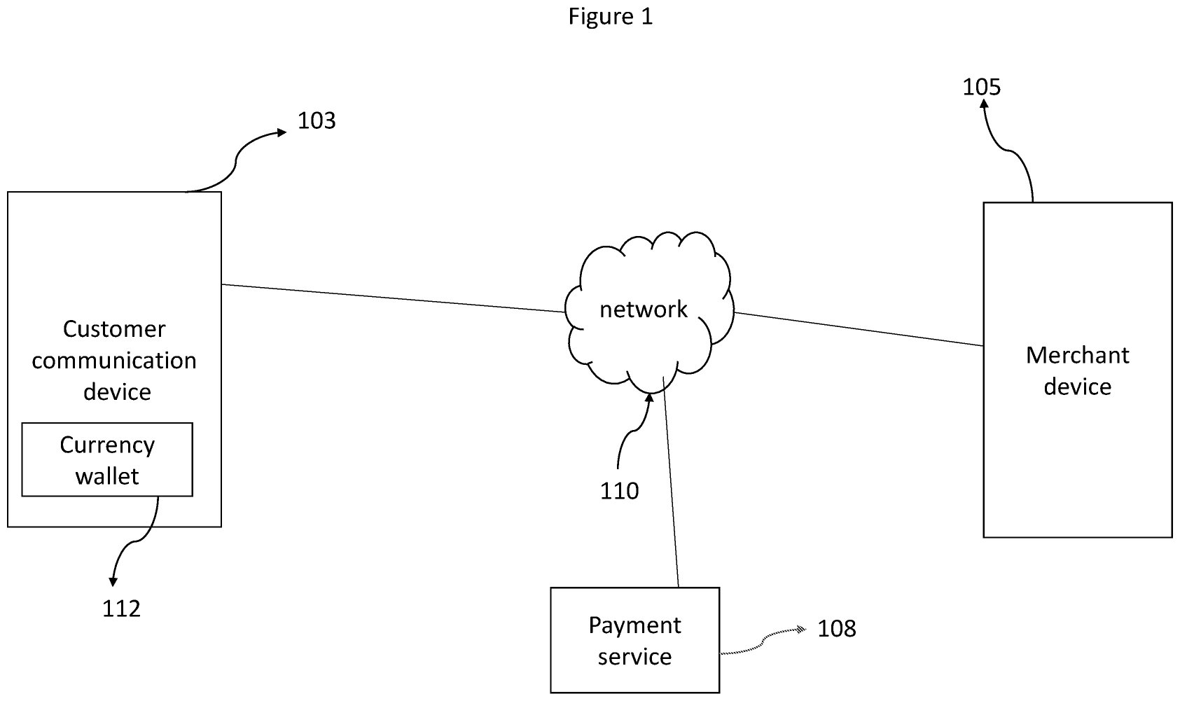

FIG. 1 shows one example of a cryptocurrency environment in which cryptocurrency transactions may be performed between two parties. For purposes of illustration and not as a limitation on the subject matter described herein, one of the parties will be referred to as a customer and the other party will be referred to as a merchant. In this example the customer wishes to obtain goods or services from the merchant with payment being made using a cryptocurrency. More generally, of course, any type of cryptocurrency transaction may be conducted between the parties.

As shown, a customer communication device 103 (e.g., a mobile or wireless communication device such as a smartphone) having a digital currency wallet 112 may engage with a merchant device 105 over one or more wired and/or wireless networks such as network 110. In some embodiments merchant device 105 may be a server that hosts a website with which the customer communication device 103 interacts to conduct the transaction. In other embodiments the merchant device 105 may be a point-of-sale (POS) terminal that processes transactions with customer communication device 103 using any suitable interface such as RFID readers, near-field communication (NFC) readers, and so on.

As part of the transaction process, the merchant device 105 can obtain transaction information describing the transaction, such as the identifier of the payment instrument (e.g., the cryptocurrency being used), an amount of payment to be received from the customer, the item(s) to be acquired by the customer, a time, place and date of the transaction, a name or user account of the customer, contact information of the customer, type of the currency, and so forth.

The merchant device 105 and/or the customer communication device 103 can send the transaction information to payment service 108 over network 110, either substantially contemporaneously with the conducting of the transaction (in the case of online transactions) or, if the merchant device 105 sends the information, at a later time when the merchant device 105 is in an online mode (in the case offline transactions).

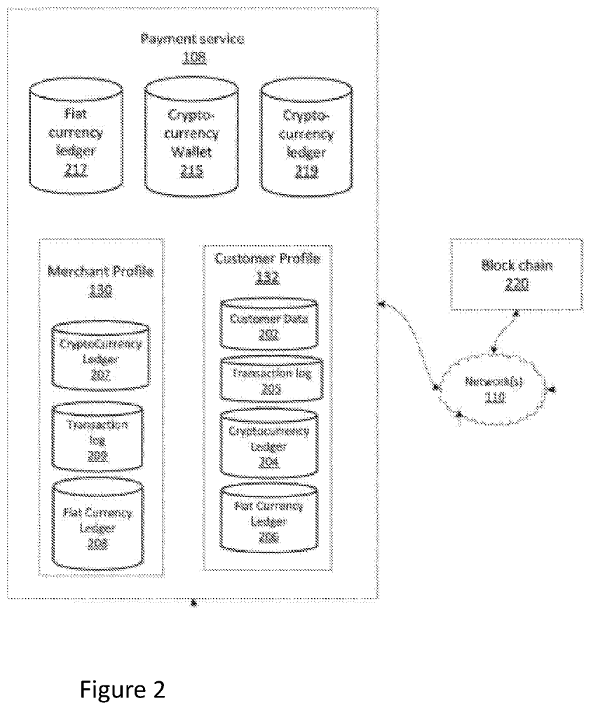

Payment service 108 is used to facilitate the transaction between the customer and merchant. Payment service 108 may be configured in a wide variety of different ways depending on factors such as the nature of the transaction, the type of merchant(s) involved, the type of cryptocurrency being employed, and so on. One illustrative example of the payment service 108 is shown in FIG. 2. As shown, payment service 108 can store a customer profile 132. Customer profile 132 can include, by way of illustration, customer data 202 which can include customer identifying information (name, contact information, etc.), records of past transactions 205 involving payment service 108 by customer 104, information regarding linked accounts and information regarding services utilized by customer profile 132 (e.g., whether the account utilizes a digital currency wallet provided by payment service 108, etc.).

In addition to customer data 202, customer profile 132 may also include a ledger for any accounts managed by payment service 108 on behalf of the customer. For instance, customer profile 132 may include customer cryptocurrency ledger 204, and a customer fiat currency ledger 206 indicating that customer 104 utilizes payment service 108 to manage accounts for a cryptocurrency and a fiat currency (such as US dollars), respectively.

Each account ledger 204, 206 can reflect a positive balance when the customer funds the accounts. An account can be funded by transferring currency in the form associated with the account from an external account (e.g., transferring a value of cryptocurrency to the payment service 108 and the value is credited as a balance in cryptocurrency ledger 204), or by purchasing currency in the form associated with the account from the payment service using currency in a different form (e.g., buying a value of cryptocurrency from payment service 108 using a value of fiat currency reflected in fiat currency ledger 206, and crediting the value of cryptocurrency in cryptocurrency ledger 204). When an account is funded by transferring cryptocurrency from an external account, an update to a public distributed ledger such as blockchain 220 may be performed.

The customer profile 132 may also include a transaction log 205, which maintains records of past transactions involving payment service 108 and the customer.

The customer may have a balance of cryptocurrency stored in the digital currency wallet 112 on customer communication device 103 and the customer can transfer all or a portion of the balance of the cryptocurrency stored in the digital currency wallet 112 to the payment service 108.

The payment service 108 may also have a merchant profile 130 that may include any of the data ledgers and logs included in the customer profile 132 such as cryptocurrency ledger 207, transaction log 209 and fiat currency ledger 208. In addition, merchant profile 130 may also include various business rules and requirements that the merchant requires to be satisfied in order to complete a transaction.

In some embodiments some or all of the functionality performed by the payment service 108 may be executed using one or more smart contracts. Smart contracts are computer programs that both express the contents of a contractual agreement and operate to implement the content, based on triggers that may be provided, for instance, by the users of the smart contract or extracted from a blockchain environment. Smart contracts may have a user interface and often emulate the logic of contractual clauses. In those embodiments that employ a blockchain environment, the smart contracts may be scripts stored on the blockchain. Since they reside on the chain, smart contracts have a unique address. The smart contract may be triggered by messages or transactions sent to its address. The smart contract may include logic to implement business rules specified by the merchant as well as the various technical functions necessary to execute a transaction. In some cases, some or all of the aforementioned rules and requirements that are required by the merchant profile 130 may be implemented as smart contracts.

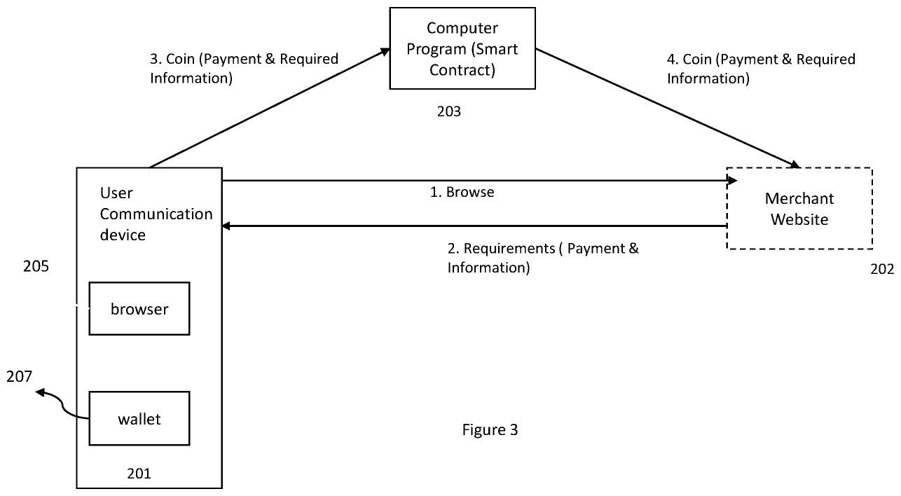

FIG. 3 shows one example of the messages exchanged between a user communication device 201 and a merchant device 202 (e.g., a merchant website) when executing a two-legged transaction that employs a smart contract 203 to mediate the transaction. A browser 205 or other application on the user communication device 201 is used to browse the merchant website 202 (step 1). The browsing activity results in the consumer being made aware of the information and the payment needed for various goods and services (step 2). The consumer may now issue commands to begin the transaction. The currency wallet 207 on the user communication device 201 may extract or create as needed an amount of cryptocurrency (i.e., a payment value) that is incorporated in a data object referred to herein as a coin or token. The terms coin and token will be used interchangeably herein. The coin and any necessary associated user information is transmitted to the smart contract 203 (step 3). Step 3 may be said to comprise the first leg of the transaction. The smart contact may now verify the payment and information components of the received coin and, upon successful verification, initiate a transaction with the merchant device 202 (step 4). Step 4 may be said to comprise the second leg of the transaction. Finally, the smart contract may optionally record the transaction in a distributed ledger such as a blockchain (not shown in FIG. 3). If the blockchain record is examined, it will show two transactions, the first initiated by the user communication device 201 and the second initiated by the smart contact 203.

It should be noted that FIG. 3 represents only one illustrative example of a method for the implementation a cryptocurrency transaction using a smart contract. However, the techniques and systems described herein more generally may be used in conjunction with other methods of implementing cryptocurrency transactions that may or may not employ smart contracts. Moreover, the techniques and systems described herein may employ any suitable type of cryptocurrency coin, including, but not limited to, such well-known cryptocurrency coins as Bitcoin, Ethereum, Litecoin, and the like. Another illustrative cryptocurrency coin or token that may be employed uses technologies described in co-pending U.S. patent application Ser. Nos. 16/006,966, 16/036,012 and 16/160,284, which are hereby incorporated by reference in their entirety. A brief description of the cryptographic techniques used to generate this cryptocurrency coin or token will now be presented. Additional details may be found in the aforementioned U.S. Patent Applications.

In general, these techniques employ a computer program f that encapsulates a spending right (a cryptocurrency amount or payment) to perform a transaction. Such programs are referred to herein as cryptographic transaction programs. For instance, one illustrative cryptographic transaction computer program f₁ described in the aforementioned U.S. Patent Applications generates a coin or token that transfers a spending right between two communication devices. Another illustrative cryptographic transaction computer program f₂ splits a spending right and transfers one part of the spending right while retaining the other part. Yet another illustrative cryptographic transaction computer program f₃ takes as input two spending rights embodied in two different tokens and generates a single token that embodies the sum of the two individual spending rights.

One important aspect of this technique for generating a coin or token is that it also generates a proof that can be used to verify that the cryptographic transaction computer program f performed the transaction using the spending right. The cryptographic coin or token, along with the proof, is referred to herein as a cryptographic credential. The two components of the cryptographic credential may be generated using the following encryption scheme.

An encryption scheme is a triple (G,E,D) where “G” is a computer program called the key generator (or key generating engine), “E” is a computer program called the encryption engine and “D” is a computer program called the decryption engine. For every (e,d) in the range of G and for every α∈(0,1)% computer programs E (encryption) and D (decryption) satisfy Probability[D(d,E(e,α))=α]=1. In words, any bit string encrypted by the computer program E can be decrypted by the computer program D. The string E(e,α)=β is the encryption of the plaintext α using the encryption e whereas D(d,β) is the decryption of β using the decryption key d. In a public key scheme, e≠d; in a private key scheme e=d. The elements of the pair (e, d) are called encryption and decryption keys, respectively. Further details can be found in O. Goldreich, Foundations of Cryptography, Vol. 2, Cambridge University Press, 2004.

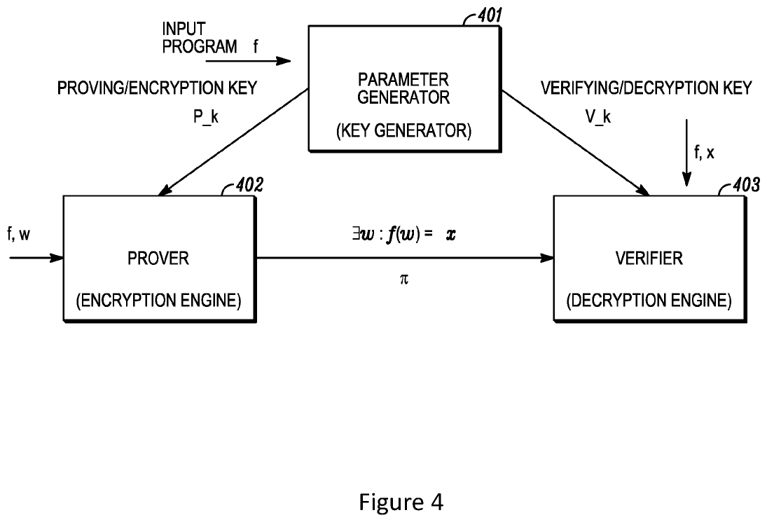

A (private key) variant of the above scheme called the proof of zero knowledge protocol (cf. D. Genkin et al., Privacy in Decentralized Cryptocurrencies, Comm. Of the ACM 61.6, 2018, pg. 78-88, which is hereby incorporated by reference in its entirety), is illustrated in FIG. 4. As shown, the cryptographic transaction computer program f is provided as an input to a key generator 401. The key generator 401 produces an encryption key Pₖ (also called the proving key) and a decryption key (also called the verifying key), Vₖ.

The encryption key Pₖ is provided to an encryption engine 402 and the decryption key is provided to a decryption engine 403.

The encryption engine 402 may be described as a computer program that takes as input a program (which may or may not be a cryptographic transaction computer program), say f the encryption key, Pₖ, and the input w to the computer program f. It runs the program f on input w and produces a pair (x, π) as its output where x is the output of the program f and π is a (cryptographic) proof of the execution of the program f. If, for instance, f is a cryptographic transaction program of the type described above and w is the spending right, the output x is a cryptographic coin or token.

A decryption engine 403, using the decryption key, Vₖ, verifies the proof π of the assertion ∃w f(w)=x. (The engine reports “true” if verification succeeds; else it returns “false”.) The soundness of the scheme asserts that the Probability [ [symbol] w: f (w)=x] is negligible. The zero-knowledge assertion is that the decryption process does not yield any information, at least none that could not be inferred by other non-cryptographic means. (Trivially, output x may be asserted in the clear.)

In some embodiments, the decryption key Vₖ, may be provided to a distributed ledger such as a blockchain system for storage. In such a case, the decryption engine may retrieve the stored decryption key as needed to verify a proof presented to it.

The cryptographic techniques described above that convert spending rights into a verifiable cryptographic credential for performing transactions involving cryptocurrencies may also be used to capture user information and convert them into cryptographic credentials that are inscrutable. When shared with third parties the cryptographic credential may be verified by the recipients (or agents acting on behalf of the recipients) without recourse to the underlying user information. As a simple example, a consumer's date of birth data may be converted into a cryptographic credential that asserts that the consumer is more than 18 years old. This cryptographic credential may then be transmitted to a third party who is then enabled by the cryptographic technology to verify the received cryptographic credential without possessing the originator's date of birth data. Such techniques were collectively labeled as selective anonymity techniques in the co-pending U.S. patent applications cited above.

To illustrate the use of this technique to generate the aforementioned cryptographic credential that asserts that the consumer is more than 21 years old, assume that the computer program f, instead of being a cryptographic transaction program as described above that is used to generate a coin or token, is a simple program that takes a user's date of birth as input w and computes if the user's age is greater than 21 by subtracting the current date from the input date of birth and verifying the result to be greater than 21 years. Those of ordinary skill in the art are well versed in writing programs of this type.

The program f is now used as the input to the key generator 401, which produces an encryption and decryption key. The program f and the input date of birth, w, are input to the encryption engine 402, which produces plaintext output x and a cryptographic proof, π, of the execution of the program f. The user may now present (x, π) as the cryptographic credential asserting that his age is greater than 21 without, in fact, revealing his date of birth (i.e., the secret, w) to any third party who may verify the cryptographic credential by recourse to the decryption engine 403, which in some cases may be maintained and operated by a decryption service. That is, the cryptographic credential (x, π) comprises the assertion x (viz., that program f, using an unknown input w, ran and produced the statement x) and the proof π of that alleged execution of f.

It is also important to observe that since the encryption engine encrypts the computer program f, the soundness property guarantees that the program f was unchanged, or else the proof π could not have been verified. We refer to this as the provenance of the program f being guaranteed by the soundness property of the cryptographic scheme.

It is important to understand what is entailed by verifying a proof π in the context of a program f that converts user information into a cryptographic credential. A party verifying such a proof π does not know w (which is the user information held in secret by the user) but believes that a program f executed on the unknown input produced the assertion x as output and that π is a proof of the alleged execution of f. That is, the believer cannot in good faith believe in the validity of w; for all he knows, the user may have lied about his date of birth, w, in the above example. But he can believe, on mathematical grounds, the alleged execution of the program f if the proof π can be verified. Thus, the trust model requests belief in the execution of the computer program f. To trust the input w to f as being valid, we must look to the program f as checking the validity of its input w. For example, if the program f were to be run on a credential or other input data provided by the Motor Vehicle Agency or other government agency, or if f is designed to check the validity of w, e.g., by checking for identification data provided by the Motor Vehicle Agency, then the believer may find w more trustworthy.

Thus, the believer is justified in possessing varying degrees of trust based on the capabilities of programs such as f. Proof of execution of a program that checks for the validity of the underlying input data w (e.g., a credential such as a driver license issued by a government agency or issued by a third party) is more trustworthy than proofs of programs that accept unvalidated input data from users, all else being equal. This is completely realistic since people have many types of credentials in their lives, some of which may be acceptable and some not at different places and by different parties.

In summary, a cryptographic credential is a pair (x, it) resulting from the execution of a program, say f on input data, say w, where x, is the output of the program and π is a cryptographic proof of the execution of program f. The actual nature of x will depend on the particular program f. If, for instance, f is a cryptographic transaction program that performs a transaction on a spending right, then the output x is a cryptocurrency coin or token. In other cases f may be a program that operates on various types of information (e.g., sensor information, user-specific information such as government issued credentials and biometric data, etc.) that serves as input data and produces an output x that represents an assertion that accurately reflects the underlying input data without revealing the underlying data.

In some embodiments a cryptographic coin or token may be generated that includes two (or more) components. One component may represent a spending right and a second component may be an assertion that accurately reflects underlying input data without revealing the underlying data. Each component may have its own proof π associated with it. Stated differently, the coin or token may be a data object that includes one cryptographic credential (x1, π1) representing a cryptocurrency having a spending right x1 and another cryptographic credential (x2, π2) having an assertion x2 representing or reflecting underlying data such as user data. The former cryptographic credential may be referred to as a spending right or payment cryptographic credential and the latter cryptographic credential may be referred to as a user data cryptographic credential.

Furthermore, both the above credentials may be “linked” together by a third proof ensuring that the user data and the spending right pertain to the same coin. That is, coin(((x1, π1), (x2, π2)), π3).

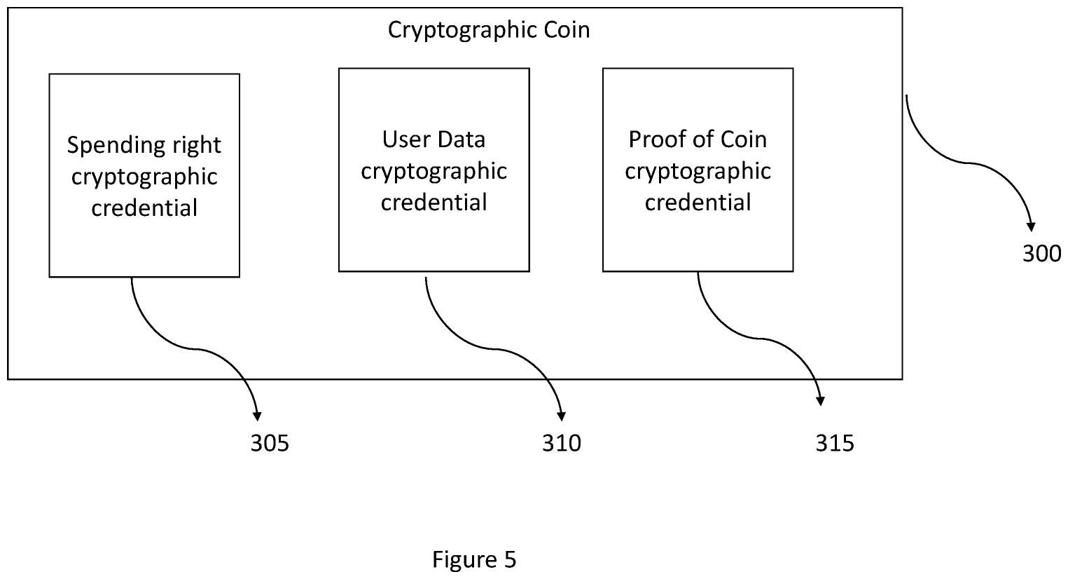

FIG. 5 shows an exemplary cryptographic coin 300 comprising a spending right cryptographic credential 305 and a user data cryptographic credential 310. In addition to the individual cryptographic credentials that make up the cryptographic coin 300, the coin 300 itself is produced as the output x of another computer program. Thus, the coin 300 also includes a proof of coin 315 that verifies the execution of the computer program that produced the coin 300 that encapsulates the spending right cryptographic credential 305 and the user data cryptographic credential 310.

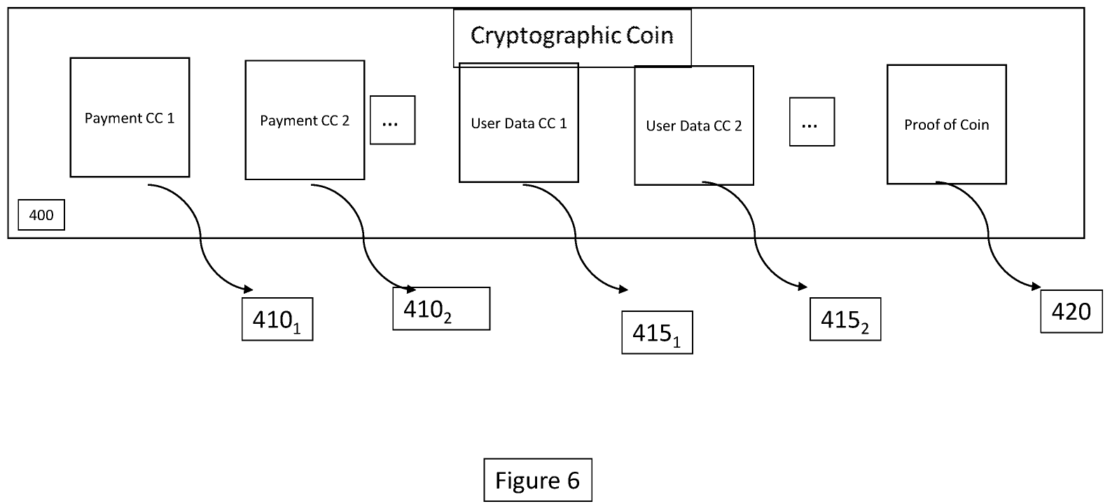

Moreover, in other embodiments, the cryptographic coin or token may include multiple payment cryptographic credentials (and optionally one or more user data cryptographic credentials). For instance, FIG. 6 shows a cryptographic coin or token 400 that includes payment cryptographic credentials 4101 and 410₂ as well as user data cryptographic credentials 4151 and 4152. The coin or token 400 also includes a proof of coin 420. In general, a cryptographic coin or token may include any number and combination of payment cryptographic credentials and user data cryptographic credentials. Importantly, in some embodiments the different spending rights in the different payment cryptographic credentials may use different currencies. For instance, one payment cryptographic credential may use fiat currency whereas another payment cryptographic credential in the same coin may use a cryptographic currency. Likewise, a single coin may include multiple payment cryptographic credentials employing different fiat currencies and/or different cryptographic currencies. Of course, in other embodiments the different spending rights in the different cryptograhic credential all may use the same currency.

A number of advantages arise from the provision of any of the aforementioned cryptocurrency coins or tokens with more than one spending right component. For instance, the volatility issue can be ameliorated by providing one spending right component in a fiat currency and another spending right component denoting a particular cryptocurrency. Consequently, the currency may act as a stable currency for some transactions and as a non-stable currency for other transactions. The currency may also be used in transactions requiring payments in foreign currencies. Additionally, it may be used to pay taxes and levies that may be required to be paid in a fiat currency, necessitating a conversion between a cryptographic currency and fiat currencies. It also obviates the necessity of merchant websites to display prices in various cryptographic currencies; rather, the websites may continue to display prices in their preferred fiat currency format.

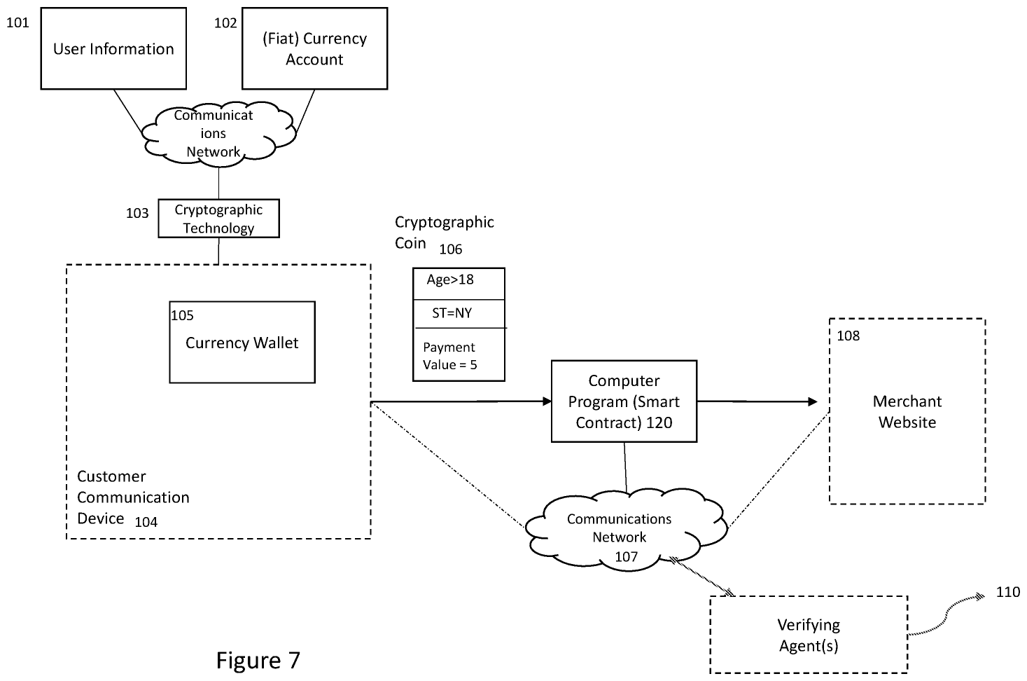

FIG. 7 shows one particular implementation of the cryptocurrency environment of FIG. 1 in which the cryptocurrency that is employed is based on the coins or tokens described above in which spending rights are incorporated in verifiable cryptographic credentials. Similar to the environment of FIG. 1, FIG. 7 shows a user or customer communication device 104 that may engage with a merchant device 108 (e.g., a merchant website or POS terminal) over one or more communication networks 107. The customer communication device 104 includes a digital currency wallet 105. In this example a smart contract 120 is used to implement the functionality of the payment service 108 shown in FIG. 1 in order to facilitate the transaction between the customer and merchant. Of course, in other implementations the functionality of the payment service 108 may be implemented by other means, both automated and manual.

The digital currency wallet 105 may be provisioned with cryptocurrency before the transaction with the merchant device 108 is to take place or at the time of the transaction. In either case, the customer, using digital currency wallet 105, causes selected user information 101 associated with the user and spending rights contained in a fiat currency account 102 (e.g., a U.S. dollar denominated bank account) to be converted into a cryptographic coin or token 106 using the cryptographic techniques described above and which are represented generally in FIG. 7 by cryptographic technology 103. As shown, in this example, the cryptographic coin or token 106 includes three components: a first user data cryptographic credential asserting that the customer is older than 18 years of age, a second user data cryptographic component asserting that the customer is a resident of New York State, and a third payment cryptographic component representing a spending right having a value of 5. Of course, as discussed above, the coin or token 106 may have any number of components with any combination of spending rights and/or user data components.

Upon receiving the coin or token 106 from the customer communication device 104, the smart contract 120 may communicate the received coin to one or more service providers referred to as verifying agent(s) 110. Verifying agent(s) 100 may be provisioned with the decryption engine 403, decryption key Vₖ and program f shown in FIG. 4 so that it can verify the cryptographic credentials in the coin or token using the techniques described above. Once verification as to the authenticity of the coin's information has been received from the verifying agent(s) 110, the smart contract 120 may proceed with transferring the coin or token 106 to the merchant website 108.

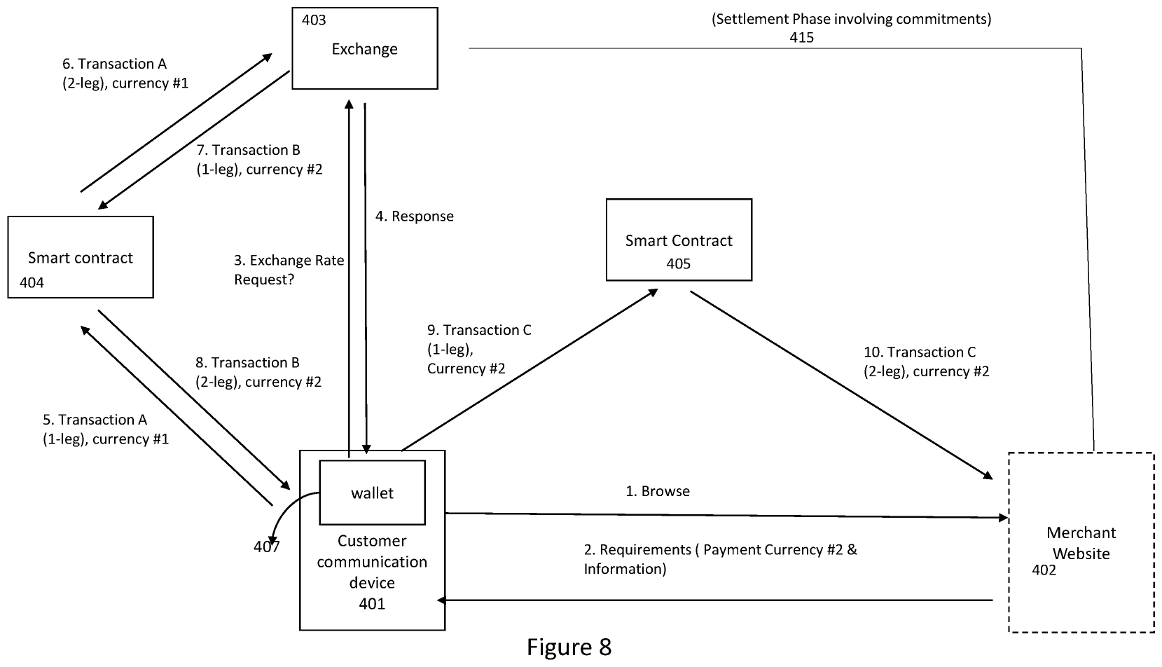

FIG. 8 illustrates an example of a transaction that occurs between a customer communication device 401 equipped with a digital wallet 407 and a merchant device such as merchant website 402 using a coin or token having two spending right components. While the coin or token is illustrated as having two spending right components, more generally the techniques described herein may be extended to coins or tokens having more than two spending right components. For simplicity, communication networks and the like that act as intermediaries facilitating communication between the entities shown in FIG. 8 have been omitted. Likewise, FIG. 8 does not show the verifying entities that verify the various transactions and the blockchain(s) wherein the transaction data may be recorded.

In this example the digital wallet 407 is provisioned with a spending right in a first cryptocurrency. However, for purposes of illustration merchant website 402 is assumed to only accept a second cryptocurrency and not the first cryptocurrency. Thus, in order to conduct the transaction, the services of an exchange 403 are used to convert between the two cryptocurrencies. The exchange 403 receives a currency transaction in a first cryptocurrency and in response provides a commitment of funds in a second cryptocurrency. The exchange 403 may settle claims against its issued commitments in an offline phase 415. In some implementations the exchange 403 may act as a broker to solicit bids from a network of service providers and choose the “best” bid to convert between the two cryptocurrencies.

The transaction between the customer communication device 401 and the merchant website 402 proceeds in accordance with the following steps illustrated in FIG. 8.
1. The customer communication device 401 browses merchant website 402 to select goods and/or services, which may have restrictions or requirements associated with their purchase. For instance, the customer may be required to be over a certain age or live in one of a select number of states in order to make the purchase. As noted above, merchant website 402 is assumed to require payment in a second cryptocurrency.
2. The necessary payment and other requirements or restrictions are communicated to the customer communication device 401 by the merchant website 402.
3. The customer communication device 401 requests a quote specifying an exchange rate from the exchange 403 for conversion between the first and second cryptocurrencies.
4. The exchange 403 responds with the requested quote. The commitments and quotes as issued by exchange 403 may be cryptographic objects. The quoted exchange rates may be time-bound, i.e., valid for a stated amount of time and expire after the stated time period.
5. The customer communication device 401, using the digital wallet 407, initiates a payment transaction “A” whose first leg is to smart contract 404 using a coin or token comprising the first cryptographic currency. Note that the coin or token only contains a single cryptographic component representing a spending right and does not contain a user data cryptographic component. The digital wallet 407 may create the needed cryptocurrency coin at the time of transaction, or it may have created coins a priori.
6. The smart contract 404 verifies the received coin and initiates the second leg of transaction “A” by sending the coin to the exchange 403.
7. In response, exchange 403 initiates a first leg of transaction “B” with the smart contract 404 and provides it with a commitment of funds in the second cryptocurrency. The commitment of funds is provided in a suitable data object such as a payment cryptographic credential.
8. The smart contract 404 initiates the second leg of transaction “B” with customer communication device 401. At the conclusion of step 8, customer communication device 401 has successfully concluded a transaction in which it has received a commitment of funds in the second cryptocurrency from exchange 403. The digital wallet 407 in the customer communication device 401 reflects the commitment fund balance.
9. The customer communication device 401 initiates the first leg of transaction “C” by sending the data object that contains the commitment in the second cryptocurrency to the smart contract 405.
10. The smart contract 405 initiates the second leg of the transaction “C” with the merchant web site 402 by sending the data object that contains the commitment in the second cryptocurrency. The settlement phase 415 between the merchant website 402 and the exchange 403 may be an offline or a real-time process in which the committed amounts are settled.

The method described above in connection with FIG. 8 uses a real-time process to convert between the two cryptocurrencies. In another case, addressed below, two (or more) cryptocurrencies are needed to perform a transaction. In this example the transaction requires one payment in a first cryptocurrency and another payment in a second cryptocurrency. The transaction will then be performed by sending a single coin that includes the two payment components. The transaction will be illustrated with the following concrete example.

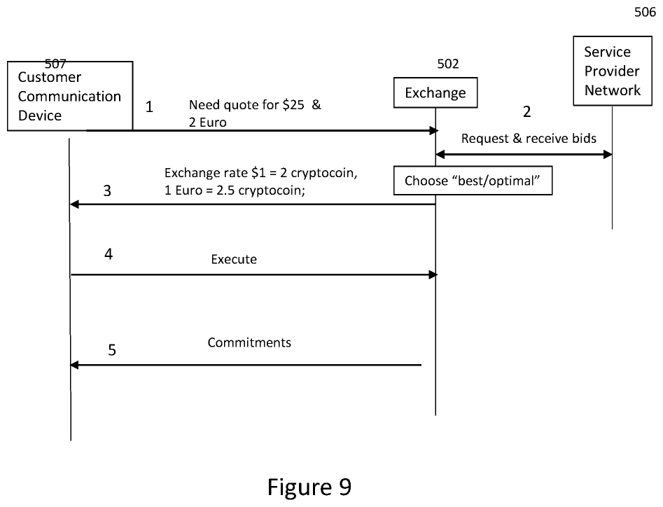

Assume a transaction is to be performed in which a payment of $25 (USD) is needed for purchased goods and services and 2 Euros are needed to pay the tax on the purchase. The consumer has a digital wallet that initially has cryptocurrency stored in it. FIG. 9 shows the exchange of messages between the consumer's communication device 507 and an exchange 502 (similar to exchange 403 in FIG. 8) for receiving a commitment to make each payment in the required currency. The sequence of messages is as follows.
1. The consumer communication device 507 requests a quote for $25 and 2 Euros from exchange 502.
2. The exchange 502 interacts with a service provider network 506 to solicit multiple “bids” and chooses the optimal or best bid (e.g., the bid with the best exchange rate).
3. The exchange 502 responds to consumer communication device 507 with the quote, which is based on the bid that is selected.
4. The consumer communication device 507 issues a request to execute the transaction.
5. The broker 502 issues commitments to consumer communication device representing $25 and 2 Euros.

While the user or consumer communication device 507 is shown in FIG. 9 initiating an exchange rate request with a single exchange, in some embodiments it may initiate the request with multiple exchanges in order to find the best exchange rate.

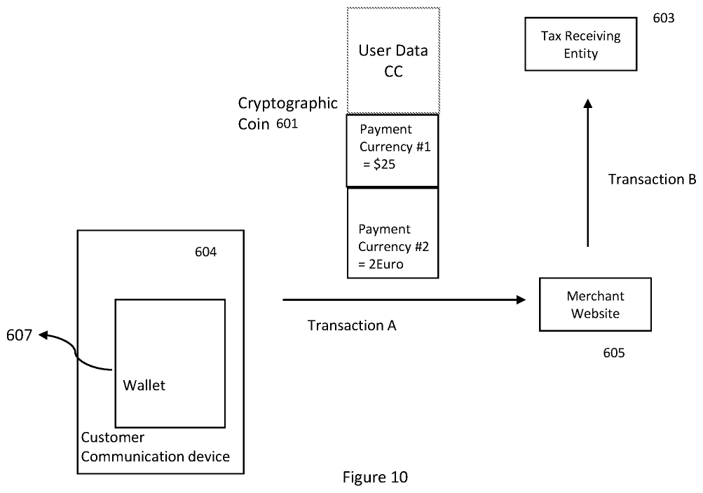

FIG. 10 illustrates a payment being made by a consumer communication device 604 to a merchant website 605. The payment is to include $25 (USD) for the purchased goods and services and 2 Euros to pay the tax on the purchase. Note that for simplicity FIG. 10 omits things such as the communication networks, smart contracts and other entities that are generally used to facilitate the transactions. The digital wallet 607 in the consumer communication device 604 provides a cryptographic coin 601 that includes three components: a payment cryptographic credential component in a first cryptocurrency (US dollars), a payment cryptographic credential component in a second cryptocurrency (Euros) and a user data cryptographic credential component that includes user information necessary to ensure that payments are applied properly.

Execution of transaction “A,” in which the consumer communication device 604 makes the payment to the merchant website 605, proceeds as described above. Next, merchant website 605 initiates a transaction “B” with Tax Receiving Entity 603. Transaction “B” uses a coin with a single payment component for 2 Euros and the user data component to demonstrate that the tax is being paid on behalf of the consumer.

It should be noted that both transactions “A” and “B” in FIG. 10 include the use of a cryptocurrency coin having a cryptographic credential component that includes a representation of underlying user data. The use of such a cryptographic credential component often may be needed. For instance, the merchant 605 and the tax entity 603 may require user information to ensure that payments are applied properly. Of course, in other cases the user data cryptographic credential component may be omitted from the cryptographic coin when not necessary.

Illustrative Computing Environment

As discussed above, aspects of the subject matter described herein may be described in the general context of computer-executable instructions, such as program modules, being executed by a computer. Generally, program modules include routines, programs, objects, components, logic, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Also, it is noted that some embodiments have been described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

The claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). However, computer readable storage media do not include transitory forms of storage such as propagating signals, for example. Of course, those skilled in the art will recognize many modifications may be made to this configuration without departing from the scope or spirit of the claimed subject matter.

Moreover, as used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

As used herein the terms “software,” computer programs,” “programs,” “computer code” and the like refer to a set of program instructions running on an arithmetical processing device such as a microprocessor or DSP chip, or as a set of logic operations implemented in circuitry such as a field-programmable gate array (FPGA) or in a semicustom or custom VLSI integrated circuit. That is, all such references to “software,” computer programs,” “programs,” “computer code,” as well as references to various “engines” and the like may be implemented in any form of logic embodied in hardware, a combination of hardware and software, software, or software in execution. Furthermore, logic embodied, for instance, exclusively in hardware may also be arranged in some embodiments to function as its own trusted execution environment.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

1. A method of generating a cryptographic coin, comprising:
generating a first spending right cryptographic credential using a proof of zero knowledge protocol, the first spending right cryptographic credential including a first cryptocurrency component and a proof that verifies that a first cryptocurrency transaction logic produced the first cryptocurrency component using as input a first spending right;
generating a second spending right cryptographic credential using the proof of zero knowledge protocol, the second spending right cryptographic credential including a second cryptocurrency component and a proof that verifies that a second cryptocurrency transaction logic produced the first cryptocurrency component using as input a second spending right; and
generating a cryptographic coin using service logic that encapsulates the first spending right cryptographic credential and the second spending right cryptographic credential using the proof of zero knowledge protocol, the cryptographic coin further including a proof that verifies that the service logic produced the cryptographic coin.

2. The method of claim 1, further comprising:
generating a user data cryptographic credential using the proof of zero knowledge protocol, the user data cryptographic credential including an assertion reflecting underlying user data and a proof that verifies that prescribed logic produced the assertion using the underlying user data as input without revealing the underlying user data; and
wherein generating the cryptographic coin includes generating the cryptographic coin using service logic that encapsulates the first spending right cryptographic credential, the second spending right cryptographic credential, and the user data cryptographic credential using the proof of zero knowledge protocol.

3. The method of claim 1, wherein the first and second cryptocurrency components are in different currencies.

4. The method of claim 3, wherein one of the different currencies is a fiat currency.

5. The method of claim 1, wherein the first and second cryptocurrency transaction logic are the same or different logic.

6. A method of generating a cryptographic coin, comprising:
generating a first spending right cryptographic credential using a proof of zero knowledge protocol, the first spending right cryptographic credential including a first cryptocurrency component and a proof that verifies that a first cryptocurrency transaction logic produced the first cryptocurrency component using as input a first spending right;
generating a user data cryptographic credential using the proof of zero knowledge protocol, the user data cryptographic credential including an assertion reflecting underlying user data and a proof that verifies that prescribed logic produced the assertion using the underlying user data as input without revealing the underlying user data; and
generating a cryptographic coin using service logic that encapsulates the first spending right cryptographic credential and the user data cryptographic credential using the proof of zero knowledge protocol, the cryptographic coin further including a proof that verifies that the service logic produced the cryptographic coin.

7. The method of claim 6, further comprising;
generating a second spending right cryptographic credential using the proof of zero knowledge protocol, the second spending right cryptographic credential including a second cryptocurrency component and a proof that verifies that a second cryptocurrency transaction logic produced the first cryptocurrency component using as input a second spending right; and
wherein generating the cryptographic coin includes generating the cryptographic coin using service logic that encapsulates the first spending right cryptographic credential, the user data cryptographic credential and the second spending right cryptographic credential using the proof of zero knowledge protocol.

8. A method of performing a transaction with a third party using a communication device, comprising:
receiving at the communication device from the third party a specification of one or more items that are to be provided to the third party to perform the transaction, the one or more items including an amount of payment that is to be provided to the third party;
using the communication device to cause a cryptographic coin to be generated, the cryptographic coin including at least a first spending right cryptographic credential that is generated using a proof of zero knowledge protocol, the first spending right cryptographic credential including a first cryptocurrency component in an amount equivalent to the payment amount needed to perform the transaction, and a proof that verifies that a first cryptocurrency transaction logic produced the first cryptocurrency component; and
using the communication device to cause the cryptocurrency coin to be provided to the third party.

9. The method of claim 8, wherein using the communication device to cause the cryptocurrency coin to be provided to the third party further includes sending the cryptocurrency coin to a computing entity that executes a smart contract facilitating the transaction.

10. The method of claim 8, wherein using the communication device to cause the cryptocurrency coin to be provided to the third party further includes sending the cryptocurrency coin over one more communication networks from the communication device.

11. The method of claim 8, wherein using the communication device to cause the cryptocurrency coin to be provided to the third party includes transmitting the cryptocurrency coin from the communication device to a point-of-sale (POS) terminal associated with the third party.

12. The method of claim 8, wherein the one or more items that are to be provided to the third party includes a representation that a user of the communication device satisfies one or more prerequisites for the transaction to be performed, the cryptocurrency coin further including a user data cryptographic credential that is generated using the proof of zero knowledge protocol, the user data cryptographic credential including an assertion reflecting underlying user data without revealing the underlying user data, the assertion asserting that the one or more prerequisites are satisfied, the user data cryptographic credential further including a proof that verifies that prescribed logic produced the assertion using the underlying user data as input without revealing the underlying user data.

13. The method of claim 12, wherein the cryptocurrency coin further includes a proof of coin that verifies that service logic was used to encapsulate the first spending right cryptographic credential and the user data cryptographic credential using the proof of zero knowledge protocol.

14. The method of claim 8, wherein the cryptocurrency coin further includes a second spending right cryptographic credential using the proof of zero knowledge protocol, the second spending right cryptographic credential including a second cryptocurrency component and a proof that verifies that a second cryptocurrency transaction logic produced the second cryptocurrency component using as input a second spending right.

15. The method of claim 14, wherein the cryptocurrency coin further includes a proof of coin that verifies that service logic was used to encapsulate the first spending right cryptographic credential and the second spending right data cryptographic credential using the proof of zero knowledge protocol.

16. The method of claim 8, wherein the one or more items that are to be provided to the third party includes a requirement to pay the payment amount in a second currency that is different from a first currency used in the first cryptocurrency component of the first spending right cryptographic credential and further comprising using the communication device to cause the spending right in the first cryptocurrency component to be converted from the first currency to the second currency prior to causing the cryptocurrency coin to be provided to the third party.

17. The method of claim 16, wherein the second currency is a fiat currency.

18. The method of claim 17, wherein the first currency is a cryptocurrency.

19. The method of claim 16, wherein using the communication device to cause the spending right in the first cryptocurrency component to be converted from the first currency to the second currency includes causing a currency exchange to provide a commitment of funds for the payment amount in the second currency.

20. The method of claim 8, wherein the payment includes first and second payment amount portions and the one or more items that are to be provided to the third party includes a requirement to pay the first portion in a first currency and the second portion in a second currency, wherein the cryptocurrency coin further includes a second spending right cryptographic credential using the proof of zero knowledge protocol, the second spending right cryptographic credential including a second cryptocurrency component and a proof that verifies that a second cryptocurrency transaction logic produced the second cryptocurrency component using as input a second spending right, the second cryptocurrency component being in the second currency for payment of the second payment amount portion, the first cryptocurrency component being in the first currency for payment of the first payment amount portion.

21. The method of claim 20, wherein the cryptocurrency coin further includes a proof of coin that verifies that service logic was used to encapsulate the first spending right cryptographic credential and the second spending right data cryptographic credential using the proof of zero knowledge protocol.
